(19) United States
(12) Patent Application Publication
(10) Pub. No.: US 2010/0098886 A1
(43) Pub. Date: Apr. 22, 2010

(54) SMART COMPOSITE MATERIALS FOR PLASTIC SUBSTRATES

(75) Inventors: Bell Fong, Ville St-Laurent (CA); Mark Andrews, Westmount (CA)

Correspondence Address: FULBRIGHT & JAWORSKI L.L.P., 600 CONGRESS AVE., SUITE 2400, AUSTIN, TX, 78701, US

(73) Assignee: Silk Displays, Montreal (CA)

(21) Appl. No.: 11/574,175

(22) PCT Filed: Sep. 13, 2005
(86) PCT No.: PCT/CA05/01397

§ 371 Date: Dec. 14, 2009

Related U.S. Application Data
(60) Provisional application No. 60/608,890, filed on Sep. 13, 2004.

(51) Int. Cl. C09K 19/00; H01J 9/20; B32B 9/04; B32B 27/40; B32B 27/30; B32B 27/32; B32B 27/34; B32B 27/36; B32B 27/08; B32B 27/38; B32B 7/12

(52) U.S. Cl. 428/1.6; 445/22; 428/411.1; 428/423.1; 428/522; 428/523; 428/446; 428/702; 428/474.4; 428/480; 428/412; 428/413; 428/473.5

(57) ABSTRACT

A shapeable multilayer composite, and method of making same, having dimensional stability. The composite comprises at least two polymer substrates, each polymer substrate having a first and second surface and each of the at least two polymer substrates being positioned sequentially such that each two consecutive polymer substrates are bonded together. Furthermore, a shapeable composite material, and method of making same, for use in the fabrication of liquid crystal displays using a shapeable multilayer composite as described above.

### FIELD OF THE INVENTION

The present invention relates to a substantially plastic composite comprising a plurality of layers of different compositions for the purpose of conferring special properties on the composite that allow it to meet with a variety of performance requirements for various manufacturing processes and intended applications.

In particular, but not exclusively and without loss of generality, the present invention relates to substantially plastic composites for use in display devices.

### BACKGROUND OF THE INVENTION

There is an increased demand for advanced polymer materials having special properties that guarantee performance in given applications. Moreover, there is a need for new developments in multilayer film structures combining high cost and low cost polymers.

For example, the current industry practice in making flat panel displays based on liquid crystal media is to use glass as the structural material and the material on which many processing steps are conducted. Referring to FIG. 1, the processing steps for a bottom glass substrate 109 may consist of the following: fabrication of an active element such as thin film transistors (TFT) 113 in a matrix format, followed by deposition of a conductive layer 108 such as indium tin oxide (ITO) and a thin alignment layer 105 for the bottom part of a so-called active display. (In a passively addressed display, a transparent conductor is patterned into a series of mutually perpendicular lines, i.e., row and column electrodes. The row and column electrodes define a plurality of cells.) The processing steps for a top glass substrate 102 may consist of the following: fabrication of a color filter matrix 103, deposition of a conductive layer 104 such as indium tin oxide (ITO), followed by a thin alignment layer 107. Both glass substrates 102 and 109 are then assembled with seals around the perimeter, spacers 112, and liquid crystal material 106 injected by vacuum into the cavity between the glass plates 102 and 109. Final assembly includes the attachment of polarizing films 101 and 110, and a light source 114 through a backlight 111.

Glass is widely used for the substrates because it is a general-purpose material, offering many of the characteristics required for display manufacturing. These characteristics include: resistance to high temperatures, dimensional stability, barrier to moisture, solvent resistance, structural strength, rigidity, and transparency. The liquid crystal material, in combination with polarizing films, modulates the light under control of the TFTs. Liquid material occupies a certain volume determined by the space between the two glass substrates 102 and 109 (known as the cell gap). Spacers are used to define the thickness of the cell gap precisely. TFTs were developed so that the active elements may be fabricated within this cell gap dimension. The architecture of current displays is based on a pixel element comprised of three primary color sub-pixels.

The role of the polarizing films 101 and 110 may be understood in terms of how the liquid crystal medium functions. Liquid crystal materials take advantage of the polarization state of light. In one orientation, polarized light is transmitted by the liquid crystal medium with no change in polarization state (black or “off” state). No light is transmitted when the top polarizer (plastic film, for example) is orthogonal to the incident light polarization. Under the electric field applied via a TFT, a change in the liquid crystal material orientation (twisting, for example) changes polarization and in turn adjusts the polarization of the transmitted light. Depending on the degree of polarization change, varying amounts of light are transmitted. Thus the level of light intensity is modulated.

A typical flat panel display comprises a matrix of pixels, which in turn comprises three sub-pixels, each representing a primary color, usually red, green, and blue. Each sub-pixel functions as described above. By varying the intensities of the three colors simultaneously, the human eye perceives the pixel as a given color. By causing such variations over the entire matrix, one may create a color image.

This approach to flat panel displays presents several disadvantages. Glass is a brittle and fragile material, making it unsuitable for environments where shock and vibrations are hazards unless expensive and complex steps are taken to protect the glass. Glass is dense and heavy, adding to the weight of larger displays. Liquid crystal material is handled as a liquid, requiring spacers and seals, and vacuum injection techniques. All of these requirements add to the cost and complexity of the manufacturing process.

In conventional liquid crystal displays (LCDs) manufacturing methods, each of the two glass plates is processed separately. The processing of each plate includes the deposition of various layers, device patterning and other techniques. After each plate is processed, it is mated with its complement and liquid crystal material is injected into the gap between the two plates. In recent advances, some manufacturers have replaced the glass plates with plastic. In all cases, manufacturers have adopted a “monolithic” approach, which means that a single polymer film is selected as the substrate material in an attempt to meet conflicting processing requirements as described above. These approaches are not successful from a manufacturing perspective because no single polymer (monolith) can meet all of the processing criteria simultaneously. Therefore, there is a need for a “smart” structure consisting of a composite or plurality of polymer layers that, when judiciously combined, adjusts itself without external intervention to process conditions so as to confer the desired performance characteristics on the final product. Without loss of generality, a typical application of such a smart (adaptive) composite laminate would be in the liquid crystal display industry.

There are a number of drawbacks to current manufacturing methods for substrates, and for substrates in relation to the flat panel liquid crystal display industry in general. Processing the glass plates (or substrates) separately is time consuming or, alternatively, expensive if another processing line is added to process plates in parallel. Further; each of the complementary plates may experience different processing conditions resulting in errors when registering the plates. Also, the alignment process itself is susceptible to error. Processing is further complicated by the use of plastic materials. Such plastics are typically very thin, light, flexible and generally troublesome to handle without damage. Furthermore, typical alignment systems are optical in nature and developed for use with rigid materials.

There is, therefore, a need to develop a replacement for the glass substrates in the manufacture of flat panel displays, and more generally, in the manufacture of displays which may be either planar or non-planar, such as, for example, curved displays. There is also a need for a method and material that would allow electronics to be built into the material. There is further a need for a process to make a suitable replacement for the glass substrate. The development of flexible and robust plastic displays would lead to enhancements in both the variety and usage of display products. In particular, flexibility opens up to an entirely new display market where conformability and wearability are leader concepts. Plastic substrates exhibit, as main advantages in comparison with glass, a reduction in weight and thickness of the display, and virtually eliminate the problem of display breakage during both fabrication and use. Furthermore, plastic substrates offer the possibility of significant reductions in cost due to their compatibility with roll-to-roll (R2R) processing and printing technology.

Plastic has to offer several of the properties of glass to replace the latter in an LCD (Liquid Crystal Display). These properties include clarity, dimensional stability, barrier characteristics, solvent resistance, low coefficient of thermal expansion, smoothness of surface, adhesive strength, and resistance to cracking. Since no plastic film can meet all with of these requirements simultaneously, a possible solution is to develop a plastic based material made from a composite multilayer structure.

Known methods have sought to replace the glass substrates with plastic. In one approach, Yamanaka et al., describe in U.S. Pat. No. 6,304,309, issued on Oct. 16, 2001, a liquid crystal display device having a plurality of liquid crystal layers stacked on a plastic substrate, which is a resin film monolith, a multiplicity of columnar supporting members, an adhesive layer, and a liquid crystal layer. The approach of Yamanaka et al., does not create a plastic multilayer material designed to address the conflicting issues discussed below. More precisely, the plastic substrate member is a monolithic element that is not a composite suitable to meet with the requirements of high optical clarity, smoothness, dimensional stability, mechanical stability, thermal stability and barrier to water and solvents. Similarly, in an article entitled: “Monolithically integrated, flexible display of polymer-dispersed liquid crystal driven by rubber-stamped organic thin-film transistors”, Applied Physics Letters, vol. 78, p 3592, P. Mach et al., describe the use of monolithic polyethylene naphthalate (PEN) superstrates and substrates to fabricate a liquid crystal display device using polymer dispersed liquid crystal as the switching element. In this case too, the prototype falls short of the desired objective for manufacturability, that is to produce a plastic material, non-monolithic in nature, that meets the conflicting requirements of manufacturing process conditions. In Optical Engineering vol. 41 p 2195, Fujikake et al., describe properties of a flexible ferroelectric liquid crystal (FLC) device containing polymer fibers between thin plastic sheets. The plastic sheet of polycarbonate is a generic monolithic material that has not been improved or adapted in a manner to improve its manufacturability. The same conclusion holds for the substrate described in the article entitled “Rollable polymer-stabilized ferroelectric liquid crystal device using thin plastic sheets” (Sato et al., Optical Review, vol. 10, p 352).

In U.S. Pat. No. 5,399,390 granted on Mar. 21, 1995, Akins describes a liquid crystal device with a substantially monolithic polymeric substrate that is not a composite suitable to meet with the requirements of high optical clarity, smoothness, dimensional stability, mechanical stability, thermal stability, and barrier to water and solvents. Some authors have focused on methods for transferring TFT circuits from various non-plastic substrates onto plastic sheets. For example, U.S. Pat. No. 6,372,608 granted to Shimoda et al., on Apr. 16, 2002 and also the article entitled “Low Temperature Poly-Si TFT LCD Transferred onto Plastic Substrate Using Surface Free Technology by Laser Ablation/Annealing” in the Journal of Asia Display/IDW 2001, pp. 339-342, Shimoda et al., disclose a method for separating a thin film device from a glass substrate by means of a high energy laser beam. U.S. Pat. No. 6,696,325 granted to Tsai et al., on Feb. 24, 2004 discloses a method for transferring a thin film device onto a plastic layer. None of these techniques is in commercial production, and none addresses the additional problems associated with creating electrode patterns, orientation layers, polarization layers, barrier layers and the liquid crystal layer in the display device.

### SUMMARY OF THE INVENTION

The present invention relates to a shapeable multilayer composite having dimensional stability, the composite comprising at least two polymer substrates, each polymer substrate having a first and a second surface, each of the at least two polymer substrates being positioned sequentially such that each two consecutive polymer substrates are bonded together.

The present invention further relates to a shapeable composite material for use in the fabrication of liquid crystal displays, the composite material comprising a first support composite having a top and a bottom surface, the bottom surface of the first support composite having a first transparent electrode disposed thereon, a second support composite having a top and an bottom surface, the top surface of the second support composite having a second transparent electrode disposed thereon and a liquid crystal layer disposed between the bottom surface of the first support composite and the top surface of the second support surface. The first and second support composites being shapeable multilayer composites as described above.

The present invention also relates to a method for forming a shapeable composite material suitable for forming a liquid crystal display, the method comprising the steps of:
a) providing a first support composite having a top and an bottom surface, the bottom surface of the first support composite having a first transparent electrode disposed thereon;
b) providing a second support composite having a top and an bottom surface, the top surface of the second support composite having a second transparent electrode disposed thereon;
c) positioning a liquid crystal film between the bottom surface of the first support composite and the top surface of the second support surface;
d) bonding the first and second support composites together;

wherein the first and second support composites are shapeable multilayer composites as described above.

The present invention also relates to a method for forming a shapeable composite material suitable for forming a liquid crystal display, the method comprising the steps of:
a) providing a first support composite having a top and an bottom surface, the bottom surface of the first support composite having a first transparent electrode disposed thereon;
b) providing a second support composite having a top and an bottom surface, the top surface of the second support composite having a second transparent electrode disposed thereon;
c) patterning the transparent electrodes disposed the first and second composites;
d) forming registration features in the first and second composites;
e) filling the registrations features with liquid crystal fluid;
f) bonding the first and second support composites together;

wherein the first and second support composites are shapeable multilayer composites as described above.

The foregoing and other objects, advantages, and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a cross sectional view (not to scale) of an example of a current design for a liquid crystal display panel;

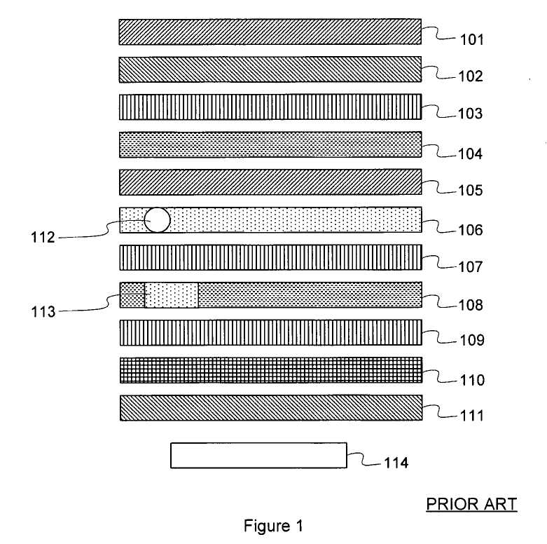

FIG. 2 is a cross sectional view (not to scale) of a non-restrictive illustrative embodiment of a plastic display panel according to the present invention;

FIG. 3 is a cross sectional view (not to scale) of a non-restrictive illustrative embodiment of a plastic display panel according to the present invention in which intermediate composite layers are grouped;

FIG. 4 is a cross sectional view (not to scale) of a non-restrictive illustrative embodiment of a smart composite in accordance with the present invention;

FIG. 5 is a cross sectional view (not to scale) showing a non-restrictive illustrative embodiment of a method of grouping intermediate composite layers which are deposited according to some sort of pattern or functional need;

FIG. 6 is a view of a typical pixel found in a plastic liquid crystal display; and

FIG. 7 is a typical performance curve of a thin film transistor found in a plastic liquid crystal display.

### DETAILED DESCRIPTION OF THE ILLUSTRATIVE EMBODIMENTS

The present invention contemplates elimination of current drawbacks in relation to the use of plastic substrates requiring simultaneously solvent resistance, dimensional stability, suppression of moisture penetration, and good optical transparency. Current industry practice has focused on the use of a monolithic polymer substrate in combination with barrier layers and other kinds of layers to make liquid crystal flat panel displays. Current industry practice is therefore limited because the monolithic polymer cannot simultaneously address the conflicting demands described above.

Non-restrictive, illustrative embodiments of the present invention will now be described. These non-restrictive, illustrative embodiments describe a composite or a plurality of polymer layers that, when judiciously combined, adjusts itself (themselves) without external intervention to process conditions so as to confer the desired performance characteristics on a final product. This smart composite material also confers added reliability to the final product in view of the manner in which it may adapt to different environmental conditions, within a specified range, so as to maintain its desired performance properties.

Generally stated, the smart composite materials according to the non-restrictive illustrative embodiments of the present invention may be used in, not exclusively and without loss of generality, the display industry. When used in the display industry, the smart composite materials present the advantage of meeting with the requirements of high optical clarity, smoothness, dimensional stability, mechanical stability, thermal stability, and barrier to water and solvents.

Without narrowing the scope of the present invention, polymers with potential for use in liquid crystal displays fall into the categories of semicrystalline, semicrystalline amorphous or amorphous thermoplastics, but solvent cast. The group of thermoplastic semicrystalline polymers includes polyethylene terephthalate (PET) e.g. DuPont Melinex, and polyethylene naphthalate (PEN). For example, DuPont Teonex PEN with a Tg (glass-transition temperature) of ˜120° C., is in the upper temperature range for the semi-crystalline thermoplastic polymers that can still be melt processed. Polymers with Tg's higher than 140° C. tend generally to have melting points that are too high to allow the polymers to be melt processed without significant degradation. The next category are polymers that are thermoplastic, but non-crystalline, and these polymers range from polycarbonate (PC) e.g. DuPont PURE-ACE and GE Lexan with a Tg of ˜150° C., to polyethersulfone (PES) e.g. Sumitomo Bakelite's Sumilite with a Tg of ˜220° C. Although thermoplastic, these polymers may also be solvent cast to give high optical clarity. The third category includes high Tg materials that cannot be melt processed. These include aromatic fluorine containing polyarylates (PAR) e.g. Ferrania's Arylite polycyclic olefin (PCO—also known as polynorbornene) e.g. Promerus's Appear and polyimide (PI) e.g. DuPont's Kapton. Table 1 lists a variety of polymers and their physical properties.

TABLE 1
Selected illustrative data for physical properties of various polymers

| | | | | | | Poly- | |
|---|---|---|---|---|---|---|---|
| | Poly- | Poly- | | | | nornornene | |
| Base | ethylene- | ethylene- | Poly- | Polyether- | Poly- | (Polycyclic | Poly- |
| Polymer | terephthalate | naphthalate | carbonate | sulfone | arylate | olefin) | imide |
| CTE | 15^{a} | 13^{a} | 60-70 | 54 | 53 | 74 | 30-60 |
| (−55-+85° C.) | | | | | | | |
| ppm/° C. | | | | | | | |
| % Transmission | >85 | 85 | >90 | 90 | 90 | 91.6 | Yellow |
| (400-700 nm) | | | | | | | |
| Water | 0.14 | 0.14 | 0.4 | 1.4 | 0.4 | 0.03 | 1.8 |
| absorption (%) | | | | | | | |
| Young's | 5.3 | 6.1 | 1.7 | 2.2 | 2.9 | 1.9 | 2.5 |
| Modulus/GPa | | | | | | | |
| Tensile | 225 | 275 | NA | 83 | 100 | 50 | 231 |
| Strength/MPa | | | | | | | |
| Glass | ~80 | ~120 | 150 | 225 | 345 | 335 | 360 |
| Transition | | | | | | | |

There are a number of issues to be dealt with before the use of plastic substrates by the liquid crystal display industry becomes widespread. Because plastics are much more temperature sensitive than glass, lower temperature deposition techniques for conducting films and alignment layers should be used. Thermal and dimensional stability are therefore controlled in order for a film to withstand high processing temperatures often encountered in display manufacturing, including the manufacture of indium tin oxide, barrier coatings and electronic circuit elements such as transistors. Among FPD (Flat-Panel Display) technologies, high quality displays are achieved by Active Matrix TFT arrays. Although plastic substrates are an alternative to glass, standard processing techniques for both amorphous silicon (a-Si) and poly-silicon (poly-Si) TFTs on glass require temperatures higher than those compatible with commonly available plastics (˜350° C. for conventional a-Si TFTs and ˜450° C. for poly-Si TFTs). Organic TFT would be a suitable technology for plastic substrates, but their performance is still unsatisfactory despite recent improvements.

Temperature variations affect dimensional stability, which is required to achieve precision registration of different layers used to make a display device. Moreover, during the manufacturing process, plastic undergoes temperature cycling. For display device manufacturing, control of dimensional reproducibility as the film is cycled in temperature is required. A film should not shrink when it is heated and cooled so that accurate alignment of features of the substrates after each thermal cycling event is not compromised. In addition, expansion of the film during temperature cycling may lead to dimensional changes large enough to fracture, crack or deform circuitry or other features deposited on the plastic film surface. For this reason the coefficient of linear expansion of the film should be as low as possible, and typically of the order of lower than 20 ppm/° C. In certain cases, polymer films may be caused to show minimal shrinkage by a process of heat stabilization. Values on the order of 0.1% and typically lower than 0.05% may be achieved. Heat stabilization may have the added effect of mitigating effects of the glass transition of the polymer. These effects are exhibited as shrinkage or expansion significant enough to prevent dimensional reproducibility necessary to deposit complex electronic circuits on plastics. When properly heat stabilized, certain plastic films remain dimensionally stable and reproducible up to significantly high substrate temperatures, of the order of greater than 200° C. The effects of heat stabilization may be conventionally measured by thermomechanical analysis. Thus heat stabilization effectively releases residual strain effects within oriented regions of the plastic film. Heat stabilization at temperatures above the glass transition for extended periods of time may further reduce shrinkage in plastic films. Plastic films may be heated (annealed) at temperatures above Tg to reduce shrinkage. Also, plastic films may be heated (annealed) at temperatures in the range Tg-T, where T is a temperature less than Tg, in order to reduce shrinkage. In turn, stabilization causes the coefficient of thermal expansion to be predictable. The coefficient of linear thermal expansion is typically measured along a machine direction and in a transverse direction, and reflects the degree of orientation within each molecular axis within the plane of the plastic film. Instead of heat stabilization of a single film, laminating or otherwise attaching two or more films together in such a way that their combined coefficients of expansion compensate one another may achieve the same effect. In this manner, a film of zero, or near-zero, expansion coefficient may be obtained. It is then possible to fabricate plastic composites comprising substrates selected from the broad class of polymers with zero or near zero coefficient of thermal expansion. In this manner, the desired reproducibility in dimensional stability may be achieved. It is the ability, therefore, to limit and to predict dimensional changes and confer dimensional reproducibility with temperature that can be exploited in a manufacturing process.

Dimensional stability in commercial semicrystalline polymers used in structural applications, such as biaxially oriented poly(ethylene terephthalate) (PET) exhibit pronounced anisotropy in mechanical properties, thermal expansion, and long-term dimensional stability. Moreover, oriented PET films shrink anisotropically due to stress relaxation over long periods of time. As described by Blumentritt in the IBM Journal of Research, vol. 23 p 66, films with nearly isotropic in-plane properties may be obtained by laminating plies of the film at various angles to one another. In this manner, films of laminates have nearly isotropic properties and greatly reduced thermal expansion coefficients.

In addition to dimensional stability, the upper processing temperature (Tp) of the plastic film or composite will be determined. Tg does not define Tp for semi-crystalline polymers, although it very nearly does so for amorphous polymers. However Tp may be changed by the application of a hard coat to a plastic film. The hardcoat may be applied to achieve solvent resistance or another form of barrier protection. In the presence of a hardcoat, Tp is defined by the thermal stability of the hardcoat.

In addition to the factors described above, moisture and solvent resistance constitute elements that may be taken into consideration in plastic composite design. Different solvents and chemicals may be used when depositing the various layers in a flat panel display. Amorphous polymers may have poor solvent resistance as compared with semicrystalline polymers. Solvent resistance may be improved by applications of hard coats. Absorption of water may be significant enough to affect dimensional stability and reproducibility. Cyclic polyolefins such as the class of polynorbornadienes have low moisture absorption (of the order of lower than 200 ppm), and it is well known to those skilled in the art that polymers may be selected and treated to reduce or significantly suppress moisture absorption.

In addition to the above factors, surface smoothness and cleanliness of the plastic composite film ensure that subsequent layers, such as barriers and conductive coatings, adhere with integrity. Surface defects (bumps and cavities) may be detrimental to conductive layer performance. Therefore, a coating layer may be applied to smooth surface defects and additionally reduce surface scratches on handling.

Extrusion coating, extrusion laminating, film laminating, and flexographic coating are four different manufacturing techniques that may be used to construct a composite structure. The physical properties and performance characteristics of a product made by extrusion coating and laminating may be identical to that made by film laminating. Many of the major components of the final structures are also the same.

Extrusion coating is the process that lays a molten layer of extrudate onto a substrate. The substrate may be paper, foil, or even a plastic film that will withstand the temperature of the extruded molten polymer. The molten polymer is a very viscous liquid that actually flows on the substrate. During this process of flowing, the polymer wets the entire surface evenly. For porous substrates such as paper, it also enters the interstices of the uneven surface. Both phenomena are contributors to adhesion. Another factor that influences the resulting bond is the specific adhesion—how well the molten polymer conforms to or matches the chemical composition of the substrate. Extrusion coating may therefore be used to fabricate a composite plastic structure.

Extrusion laminating in a converting operation is the combination of two substrates using a molten polymer. In this case, the extrudate enters the nip formed by two rolls. Two substrates also enter the nip by traveling over each roll. The extrudate is therefore the central part of a sandwich material. The same factors mentioned above—flow, substrate non-uniformity, and specific adhesion—are the factors that control the bonding of the three materials in the resulting sandwich composite. Primers are often used to promote adhesion. Application of a primer to a substrate before an extrusion coating or extrusion laminating operation uses some pieces of equipment designed for film laminating operation: a coating station and a drying station. In some instances, a laminating adhesive such as a polyurethane or polyester adhesive in solvent may find use as a primer. A general rule of thumb is to use the adhesive at about half the normally applied coating weight when using the material as an adhesive. Some materials such as polyethylene imine or ethylene acrylic acid polymers are formulated specifically for use as a primer. Extrusion lamination may therefore be used to fabricate a composite plastic structure.

Flexographic coating (also known as flexography) is a roll-to-roll method of depositing a thin film or layer of substance, including polymers and liquid crystal media, onto a second surface, which may be another polymer or composite material.

The process of film laminating differs completely from the extrusion coating and extrusion laminating processes; it is the combination of a film to another substrate—film, paper, or foil—by using a laminating adhesive. The adhesive is coated onto one substrate of the lamination, dried in an oven if it contains solvent or water, and then combined with the other substrate in a heated nip station using pressure. For finished products that contain more than two substrates, additional laminating steps may be needed. The bond values in a laminating operation depend on the specific characteristics of the laminating adhesive. Sufficient cohesive strength and necessary adhesive strength is required to bond sufficiently to each of the substrates. Other variables such as coating weight, nip temperature, treatment level, etc., will also influence the final bond value. Film laminating may also be used to fabricate a composite plastic structure.

As an example, the various materials forming the composite (laminate) are wound on rollers, and fed to a means for pressing the materials together, such as laminating rollers. In an illustrative embodiment, the edges of the composite (laminate) may be sealed after lamination. Sealing is accomplished using plastic welding methods such as ultrasonic bonding or a similar technique. In another illustrative embodiment, the composite material is sheared into sheets. In this case, the cut edges are advantageously likewise sealed. Because sheets are sealed on all four sides, the composite may be held together by vacuum until such time as separation is required.

In a further illustrative embodiment, rather than welding the edges of the composite, an adhesive may be deposited on the outer edges of the inner surface of the upper or lower plastic composite substrates to form a bond to maintain the various layers of the composite in abutting relation. In this alternative illustrative embodiment, a weak adhesive such as a release agent may be used since the upper and lower substrates of the composite may be required to be separated from one another in subsequent processing steps. The protective layers, if present, need not be welded or glued to each other or the preceding substrate layers since such layers may be removed well before the rest of the composite is separated and will remain abutted to the substrate layers via static attraction. It is possible to use a plastic welding method or an adhesive, in conjunction with laminating rollers, to bond the various layers together. In other alternative illustrative embodiments, the composite may be bonded using laminating rollers or other devices for pressing the layers together, alone. After bonding, the composite may be rolled up around a roller, or sheared into individual sheets through the use of a cutter or shearer. The composite, either rolled or sheared, is then ready for further processing.

In current applications, liquid crystal displays have been restricted in shape to flat structures. This is because the liquid crystal material is conventionally held between two rigid glass sheets, which, as described above, have been desirable for their barrier properties, optical clarity, and ease with which they may withstand the various processing conditions required to make a display. Displays may be fabricated from plastic or substantially plastic composite materials so that such displays may be shaped as desired. As an example, curved displays for television or for computer screens may be fabricated and shaped to improve viewing quality. In other illustrative embodiments, typical shapes may be rectangular concave. Other illustrative embodiments for curved displays may be in the area of automotive displays (dashboard displays) aircraft control panel displays, and displays used in machinery of different kinds. Therefore, in a further illustrative embodiment, individual sheets of polymer composite may be shaped into curved or arched forms, or may be shaped arbitrarily but in a conformal way to assume the shape of a molding body. Any of the shaping methods, such as blow molding, vacuum molding, stretching, and so forth, that are known to those skilled in the art may be used to fabricate a shape. In this manner, a composite layer is not restricted to planar forms. In the context of display technologies other than liquid crystal (such as, for example, organic light emitting diode display technologies) the display, or portions of the display, may also be fabricated from “smart composite” plastic materials, and be caused by various methods such as those described above to assume different shapes.

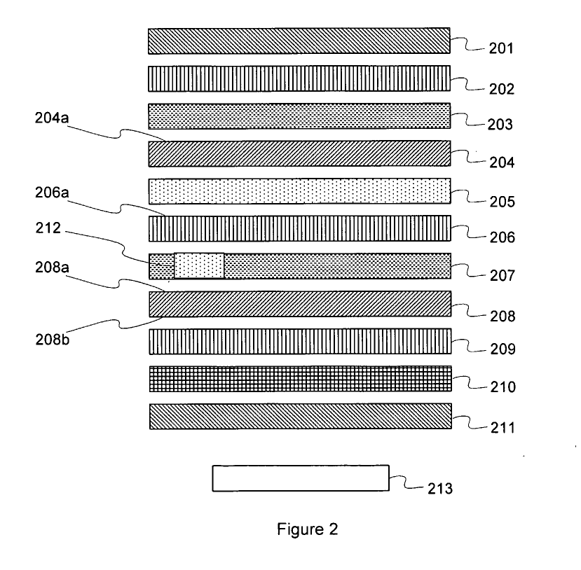

Referring to FIG. 2, there is shown a non-restrictive illustrative embodiment of the present invention. Overall, a liquid crystal polymer layer 205 is sandwiched between two patterned conducting electrode layers 204 and 206 and their associated active electronic elements 212 built into the active layer 207. The entire structure consisting of polarizers 202 and 209, and the liquid crystal, electrode and active device elements, may be supported by two substantially plastic composite support layers 208 and 203. A light source 213 diffused and distributed over the display area by bottom substrate 210 provides illumination to the display. Optical changes in the liquid crystal material are obtained by applying voltages to selected elements of the facing electrodes. Protective layers 201 and 211 provide resistance to scratches and other physical damage from agents such as solvents and may be, for example, a polymer, an acrylate, an alkoxysilyl substituted acrylate or an acrylate containing between 20% and 80% silica particles.

The functions of the plurality of layers illustrated in FIG. 2 are described by way of example, without restriction, in Table 2 in their given order. The left hand column of Table 2, under the heading LAYER, shows four main categories of layers. These layers are assembled in the order shown; that is, there is a Bottom Layer, which attaches an Electronic Layer, which attaches a Liquid Crystal Layer, which attaches a Top Layer. This constitutes the basic hierarchy of the liquid crystal display. In Table 2, the SUB-LAYER associated with each LAYER may consist of a plurality of layers. As described hereinbelow, by way of example, the plurality of layers constituting each SUB-LAYER may be assembled in different order depending on the requirements (DESIRABLE CHARACTERISTICS) of the SUB-LAYER.

TABLE 2
Characteristics and properties of the various layers of an illustrative plastic panel
display

| | | | | RELEVANT | |
|---|---|---|---|---|---|
| | | | | PROPERTY | |
| | SUB- | DESIRABLE | RANGE OF | OR | |
| LAYER | LAYER | CHARACTERISTICS | CONDITIONS | PROCESS | METHOD |
| Top | Protective | Water barrier | Diffusion | Crystallinity | Coating |
| Layer | Sub-Layer 201 | Scratch resistance | Max. moisture | Crosslink | Chemical |
| | | Impact resistance | take-up | density; | composition; |
| | | Solvent resistance | Organics | chemical | crosslinking |
| | | | Acid | composition | |
| | | | Base | Toughness | |
| | Polarizer Sub- | Retain function over | environmental | | |
| | Layer 202 | environmental end | end use | | |
| | | use range | range | | |
| Liquid | | | | | |
| Crystal | | | | | |
| layer | | | | | |
| | Support Sub- | Survives conductive | | | |
| | Layer 203 | layer deposition | | | |
| | | process (ITO) | | | |
| | | Adhesion between | | | |
| | | layers | | | |
| | Conductive | | | | |
| | Sub-Layer 204 | | | | |
| | Polymer Liquid | Adhesion between | | | |
| | Crystal Sub- | layers | | | |
| | Layer 205 | Retain function over | | | |
| | | environmental end | | | |
| | | use range | | | |
| Electronic | | | | | |
| Layer | | | | | |
| | Conductive | | | | |
| | Sub-Layer 206 | | | | |
| | Active Sub- | Insulate, planarize | | | Examine |
| | Layer | and support the | | | anisotropic |
| | (may contain | electronic structure | | | properties |
| | semiconductor | (match physical | | | impact |
| | transistors and | characteristics of this | | | |
| | a polymer film) | layer to physical | | | |
| | 207 | constraints imposed | | | |
| | | by transistors - CTEs | | | |
| | | for example) | | | |
| | | Patternable | | | |
| | | (to create windows | | | |
| | | and fill) | | | |
| | Support Sub- | Survives | | | |
| | Layer 208 | semiconductor | | | |
| | | fabrication process | | | |
| | | conditions | | | |
| Bottom | | | | | May be free |
| Layer | | | | | floating |
| | | | | | (does not |
| | | | | | have to be |
| | | | | | bonded to |
| | | | | | electronic |
| | | | | | layer) |
| | Polarizer 209 | Retain function over | | | |
| | | environmental end | | | |
| | | use range | | | |
| | Bottom | Retain relative | | | |
| | Substrate/Light | dimensional stability | | | |
| | Guide Sub- | over end use | | | |
| | Layer 210 | environmental range | | | |
| | Protective | As above | | | |
| | Sub-Layer 211 | | | | |

Referring back to FIG. 2, the top composite mostly plastic layer 203 (Table 2 Top Layer) and the bottom support composite mostly plastic layer 208 (Table 2 Bottom Layer) may be produced in different production lines. In most cases several displays may be produced on one composite layer. The bottom layer plastic composite 208 is the support for the TFT production in the case of active matrix LCDs. Both layers 203 and 208 may consist of a plurality of layers chosen so as to optimize certain properties. Both of these supports replace the glass layers conventionally used in liquid crystal display manufacture. Support layer 208 may be manufactured to have special properties such as resistance to penetration by moisture (water vapor), resistance to solvents, dimensional stability (as described above) and athermal or near-athermal behavior as described below. In a similar way, the top composite 203 may also present these, or a subset of these properties.

Plastic composites 203 and 208 may be subjected to extended bake or annealing at a temperature above 100° C. (140° C.-350° C.) for a time period of 10 minutes to 100 hours to reduce deformation in subsequent process operations. Examples of plastic substrates that may be used to make multilayer intermediate composites 203 and 208 include, but are not limited to, films consisting of one type of polymer selected from the candidates in Table 1 and combinations of thermoplastic films such as poly(etheretherketone) (PEEK), poly(aryletherketone) (PAEK), poly(sulfone) (PSF), poly(ethersulfone) (PES, including Sumilite® FST-X014), poly(estersulfone), aromatic fluorine poly(ester), poly(etherimide) (PEI), poly(etherketoneketone) (PEKK), poly(phenylenesulfide) (PPSd), oxidized polyarylenes/polyarylene sulfide/polyarylene sulfone (“Ceramer”/“Cramer Plus”) (PPS/PPSO2), cyclic olefin copolymer (Appear™ 3000), polyarylate (AryLite™ A 100HC), poly(carbonate) (PureAce), poly(ethylenenaphthalene) (PEN, and isomers thereof (e.g., 2,6-, 1,4-, 1,5-, 2,7-, and 2,3-PEN)), (including Teonex Q65®), poly(ethyleneterephthalate) (PET, including Melinex ST504®, polybutylene terephthalate, and poly-1,4-cyclohexanedimethylene terephthalate)). Other polymers include polyimides (e.g., polyacrylic imides), polycarbonates, polymethacrylates (e.g., polyisobutyl methacrylate, polypropylmethacrylate, polyethylmethacrylate, and polymethylmethacrylate), polyacrylates (e.g., polybutylacrylate and polymethylacrylate), polystyrenes (e.g., atactic polystyrene, syndiotactic polystyrene, syndiotactic poly-alpha-methyl styrene, syndiotactic polydichlorostyrene, copolymers and blends of any of these polystyrenes), polyalkylene polymers (e.g., polyethylene, polypropylene, polybutylene, polyisobutylene, and poly(4-methyl)pentene), fluorinated polymers (e.g., perfluoroalkoxy resins, polytetrafluoroethylene, fluorinated ethylene-propylene copolymers, polyvinylidene fluoride, and polychlorotrifluoroethylene), chlorinated polymers (e.g., polyvinylidene chloride and polyvinylchloride), polyacrylonitrile, polyamides, silicone resins, epoxy resins, polyvinylacetate, polyether-amides, ionomeric resins, elastomers (e.g., polybutadiene, polyisoprene, and neoprene), and polyurethanes. These films may be combined in such a way so as to prevent warping (deformation) of the substrate during processing. The resistance to warping of the composite laminate structures may be predicted from various theories, for example, as described in R. F. Gibson, “Principles of Composite Material Mechanics”, McGraw-Hill, New York, 1994. A classical lamination theory may be used to describe the behavior of composite materials under mechanical, thermal, and hygrothermal loading conditions. Optimization of the structure of a laminated anisotropic composite subjected to thermal stress may be determined through stochastic and finite element analyses of the composite thermo-elastic properties and temperature.

Alternatively, to achieve a similar warping suppression effect, a hard coat of 500-750 nm of SiO₂ at 100° C. may be deposited as layer 208a and 208b, on the top and bottom sides, respectively, of intermediate composite 208. Other materials such as tantalum oxide and silicon oxynitride, and combinations of SiO₂, tantalum oxide and silicon oxynitride, may be used instead to achieve a similar effect. Alternatively, the hard coat consisting of SiOₓ and a spin-on-glass, or a titanium oxide doped silica spin-on-glass, is printed on the substrate using, for example, flexo printer technology and is then cured and annealed in a furnace.

Alternatively, to achieve a similar effect of suppressing warping, the plastic composite 203 or 208 may be attached to a rigid substrate by means of a release agent such as a temporary adhesive. In this instance the plastic composite 203 or 208 passes with its substrate through the different processing steps, and then is released from the substrate afterwards.

Layers 206 and 207 constitute the electronic layer as indicated in Table 2. The electronic layer embodies the concept of Embedded Functionality. Layer 207 is the Active Sub-Layer, which supports the thin film active matrix transistor element 212. This latter element may be embedded in the intermediate composite sub-layer 207. Conductive Sub-Layers 206 and 204 are counter electrodes that are applied to the bottom of Support Sub-Layer 203 and on top of the Active Sub-Layer 207. The transparent electrode Conductive Sub-Layers are made by depositing indium-tin-oxide (ITO) or ITO combined with another substance, such as, for example, gold, to improve conductivity. The surface of the intermediate polymer composite is smooth, with a surface roughness Ra on the order of 2.0 nm for good performance of the ITO layer. Smoothness and surface protection may be achieved by applying a top hard coat (wear-resistant) layer interposed between the combined intermediate composites 207-208, that is at the top surface of layer 208 and the bottom surface of layer 207. Other transparent conductors (such as zinc oxide) may be used in place of ITO for the pixel electrode or transparent electrode material may be patterned into electrodes using photoresist reactive to light within a range of wavelengths. The layers 206 and 204 may be about 70 to 200 nm thick and are typically sputter deposited onto the plastic substrate. Other deposition processes may also be contemplated. The sputtering or other process is controlled so that layers 204 and 206 are transparent, easily patterned, and have a resistivity appropriate for the display application. An exemplary resistivity for the ITO layer is 100 Ω/square, and in the range of 40-500 Ω/square. The deposition of ITO by sputtering and other methods is well known to those of ordinary skill in the art. For reference see, O'Mara W., “Liquid Crystal Flat Panel Displays: Manufacturing Science and Technology”, Van Nostrand Reinhold (1993) at pp 114-117. This reference, and all other references mentioned in this specification are incorporated herein by reference in their entirety. A hard coat barrier layer 206a and 204a of sputter-deposited SiO₂ may be deposited on top of the conductive layers 206 and 204, respectively. Alternatively, the hard coat consisting of SiOₓ and a spin-on-glass is printed on the substrate using, for example, flexo-printer technology and is then cured and annealed in a furnace. The resolution of flexo-graphic printing is of the order of 40 to 100 nm. Each of the hard coats acts as a gas barrier, as described below in relation to a non-restrictive illustrative embodiment of a method for making such a barrier. Moreover, the lower protective film 206a prevents ionic impurities (like Na, Sn, In for example) derived from the electrode from migrating into the liquid crystal layer 205. In addition the top coat barrier layer 204a prevents adventitious foreign matter having a size comparable to the cell gap from entering into the liquid crystal layer 205, so that the ITO electrode conductive sub-layer 204 is electrically and mechanically stable.

To drive the liquid crystal layer 205, an active matrix of pixel transistor elements is formed on or in an intermediate composite laminate structure 207, which is subsequently attached to support layer 208. In another illustrative embodiment, active element 212 may be created directly on layer 208. Thus the pixel circuit and the counter electrodes utilize intermediate plastic composite substrates, with the pixel circuit including a thin-film transistor (TFT) and usually a storage capacitor. The TFT may be fabricated by any of the procedures known to those of ordinary skill in the art. For example, the TFT gate electrode is connected to the scan line of the pixel, the drain electrode is connected to the data line of the pixel, and the source electrode is connected to a pixel electrode. The pixel electrode may be coated with indium-doped tin oxide (ITO). If a reflective display is required, a reflective metal such as aluminum may be used. The counter electrode may be composed of a polymer (plastic) substrate coated with ITO. The individual pixel elements may be fabricated or arranged in an array to make an active matrix liquid crystal array. The pixel elements are usually made with row and column connections for an array of pixels wherein the gate electrodes of the TFTs are connected together in rows, and the drain electrodes of the TFTs are connected together in columns. The source electrode of each pixel TFT is connected to its pixel electrode, and is electrically isolated from every other circuit element in the pixel array. Other versions of TFT circuit designs may be envisioned. For example, so-called field sequential color display circuits may be used to achieve switching of the pixel array.

In another illustrative embodiment, the thin film transistor array may be fabricated from other conductive materials, such as conducting organic polymers. These may be created and patterned by methods similar to those described above, or the transistors or electrodes may be created by one or combinations of ink jet printing or micro-contact printing technology as described in Xia, Y., et al., Chem. Rev. (1999) 99 (7), 1823.

It is to be understood that the above description of the transistor array is for illustrative purposes only and is not intended to restrict the design of multiplexing the transistor array or architecture of the transistor array in any way.

Conventionally, layer 205 is a liquid crystal layer. If the layer material is selected to be of the twisted nematic or super twisted nematic type, then additional processing constraints are introduced to the manufacturing sequence. Generally, spacer particles are sprayed onto the surface of the substrate, such as intermediate composite 205. Moreover, layer 205 has a top layer of rubbed polyimide, which is used to orient the liquid crystal material. However, in conventional liquid crystal display devices the aligning film of polyimide is created through polycondensation reactions of polyamic acid, which require temperatures of 250° to 350° C. for the polymerization reaction. Therefore, this high temperature imposes a significant constraint on the choice of plastic composite substrate materials. The spacer particles define a uniform cell gap on the order of a few micrometers, depending on the choice of liquid crystal medium and the functional role of the display. The liquid crystal material is then vacuum injected into the cell gap and the whole structure eventually sealed.

In another illustrative embodiment, a layer of polymer may be embossed or otherwise created with reservoirs whose function is to contain a liquid crystal fluid. The reservoirs may then be sealed with a top layer of polymer, which adheres to the reservoir boundaries. In this manner, the height of the walls of the reservoirs defines the cell gap spacing, and there is no need for spacer particles. Moreover, the reservoirs provide the advantage of sealing the liquid crystal fluid between two or more plastic layers, a process, which may allow independent processing of the liquid crystal display element. Embossing may be achieved by a cold or hot process in which the embossing tool is either unheated (cold embossing) or heated (hot embossing). The embossing tool contains a pattern of the reservoir elements to be replicated. The pattern may consist of a square array of wells whose dimensions, distribution, density, depth and wall thickness are selected so as to be of similar, same or much smaller size than that of a given pixel element. The patterned square array of reservoirs may be selected to match precisely so that there is a one-to-one correspondence with the position of the transistors. In this case, the reservoirs define the size of the pixel elements. The reservoirs may also be fabricated by embossing into other geometric patterns that include, without restriction, arrays of hexagon shaped reservoirs of identical dimensions, arrays of circle-shaped reservoirs of identical dimensions, arrays of rectangular or square wells, and combinations thereof. Instead of hot or cold embossing, arrays of reservoirs may be created by any of the techniques of micro-contact printing as described in the literature (Xia, Y., et al., Chem. Rev. (1999) 99 (7), 1823.).

If a film of more or less solid polymer replaces the conventional twisted nematic or super twisted nematic liquid crystal, then a simplification in the manufacturing process may be achieved. For example, a film of polymeric liquid crystal (PLC) material may be used as the sub-layer 205. The terminology, polymeric liquid crystal is used in the broadest sense of the definition to include all compositions containing polymer material and liquid crystal components. According to one method liquid crystals may be stabilized by dispersing microdroplets of them in polymers at a liquid crystal concentration range of 30 to 80 weight percent (Polymer Dispersed Liquid Crystal (PDLC)). The liquid crystal assumes the discontinuous phase and the matrix is the continuous phase. Among the advantages of PDLC films over conventional liquid crystal dispersions are the ease of manufacturing on large roll-to-roll plastic supports and in the manufacture of switchable windows and displays. PDLC composites may suffer from refractive index mismatching (haze) between the discontinuous and continuous phases. PDLC materials may require high voltages, may lack resin stability, may have undesirable color, and may lack reverse-mode capability (i.e., off-state transparency/on-state opacity). Polymer Stabilized Cholesteric Texture (PSCT) liquid crystal composites have also been developed. PSCT is prepared by gelation of a mixture of about 5 weight percent ultraviolet radiation-curable prepolymer and greater than 95 weight percent cholesteric liquid crystal. After curing the display consists of a continuous liquid crystal phase stabilized (gel phase) by a polymer network. Due to the high concentration of liquid crystal in PSCT, the gel display has the disadvantage that it is prepared between rigid sealed glass supports; this requirement is the main disadvantage of this technology when used for displays.

Another non limitative example is a nematic curvilinear aligned phase (NCAP) material such as that manufactured by Raychem Corporation. Layer 205 in FIG. 2 may be used in emulsion form, such as that of NCAP. In this way the NCAP emulsion may be coated directly onto a continuous web intermediate plastic composite and the water evaporated to form a uniform film. When the web is coated in this manner, the PLC NCAP material itself creates a uniform spacing between the pixel circuit and the counter electrode. This obviates the need for spacer beads, vacuum cell filling and sealing. Polarizer sub-layers 202 and 209 may be omitted when using NCAP because contrast is created by light scattering and dye absorption alone. By omitting polarizer layers 202 and 209, displays based on NCAP may be bright in the “on” state. They may be used with or without pleochroic dyes to provide improved darkness in the “off” state. It is known that the electro-optical response curve of transmission versus voltage is not sufficiently steep for NCAP materials to allow them to be used in the same sort of multiplexing schemes designed for twisted nematic or supertwisted nematic displays. Because the NCAP materials are not typically bistable other means of multiplexing may be imposed. The use of an active matrix of TFTs on plastic allows this multiplexing limitation to be overcome and thus provides a route to flexible, plastic, bright displays with high information content. The above examples are for illustrative purposes only, since the PLC layer may be selected from any class of such polymer-based materials, which are well known to those of ordinary skill in the art.

Another non limitative example is a polymer-stabilized ferroelectric liquid crystal (FLC) material such as that provided by Chisso (CS-1030) in combination with a monofunctional acrylate monomer like Dainippon Ink UCL-001. The CS-1030 material has a cone angle of 28 degrees, a chiral smectic C phase at −5° C., a smectic A phase at 70° C., a chiral nematic phase at 74° C. and a isotropic phase at 88° C. The FLC-acrylate monomer solution of composition 20-wt % monomer exhibits a phase transition from chiral nematic to isotropic at 78° C. To be useful, the FLC-monomer solution is first heated to the nematic phase. The solution may then be sandwiched between plastic substrates having attached transparent ITO electrodes and alignment layers of a rubbed polyimide film (such AL-1254 from JSR). The alignment film orients both the FLC and monomer material. The composite structure is then illuminated with UV light at 365 nm, causing the monomer component to polymerize and the resulting polymer to phase separate from the FLC material. Cooling the composite to room temperature causes the separated liquid crystal to undergo a phase transition to the chiral smectic C phase where it exhibits ferroelectric molecular alignment. The principal achievement of this approach is that a PLC material with gray scale characteristics and fast switching time may be obtained in a quasi-“solid” polymer matrix film format.

Layer 210 is the bottom substrate layer that may act as a light guide. This may be a tapered structure whose purpose is to guide light from a light source such as 213 into the array of pixel elements. This is combined with a protective sub-layer 211 to which a light source such as a light-emitting-diode is attached. The top of the stack terminates in protective layer 201.

In reference to FIG. 2, in another non-restrictive illustrative embodiment, the polarizer layer 202 may be placed between layers 203 and 204. Similarly, polarizer layer 209 may be located between layers 207 and 208.

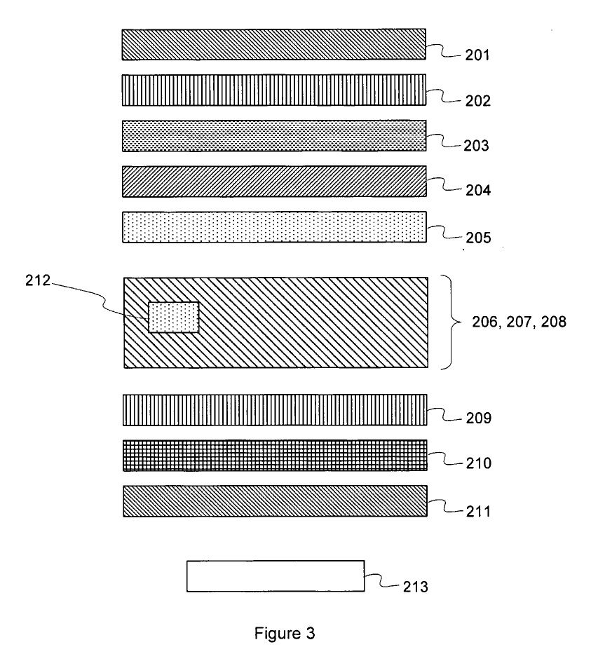

In another illustrative embodiment, shown in FIG. 3, the functionality of some layers may be combined. Thus, the functionality of conductive sub-layer 206 may be combined with that of active sub-layer 207 and support sub-layer 208. The purpose of combining layers in this manner is to ease or make optimal use of the manufacturing process. This is accomplished by designing the multilayer structure so that it is adapted to best accommodate a given set of processing conditions. For example, as explained in more detail below, sub-layer 208 on which the transistor circuit element is deposited will not only show high dimensional stability with regards to heating and cooling, but may also withstand a range of solvents used in the photolithography and cleaning processes. Therefore, a multilayer intermediate composite having all of these properties together could satisfy simultaneously a given range of process variables.

In another illustrative embodiment, polymer liquid crystal layer 205 is combined by placing it on the bottom surface of layer 204, which has already been combined with all layers above it (201, 202, 203).

In yet another illustrative embodiment, polymer liquid crystal layer 205 may be created independently in fluid or film form and subsequently deposited on layers 204, 203, 202, and 201, in that order.

In a further illustrative embodiment, polarizer layer 202 may be combined with protective layer 201. The combination of this layer may then be combined with the top surface of layer 203, which has previously been combined with layer 204. It should be understood that additional layers, such as layers stabilizing against warpage (deformation) may already have been combined with layer 203.

In a further still illustrative embodiment, the polarizer layer 209 may be first combined with support layer 208. The polarizer layer may or may not be hard-coated as described above. The combined layers 208 and 209 may then be combined with active sub-layer 207 and then combined with a conductive layer 206, or layers 206 and 207 may be combined in a previous step and then combined with the combination of layers 209 and 208.

In yet a further illustrative embodiment, the polymer liquid crystal layer 205 may be placed first on the combined layers 209, 208, 207 and 206, which in turn may have been combined in any of the manners described above.

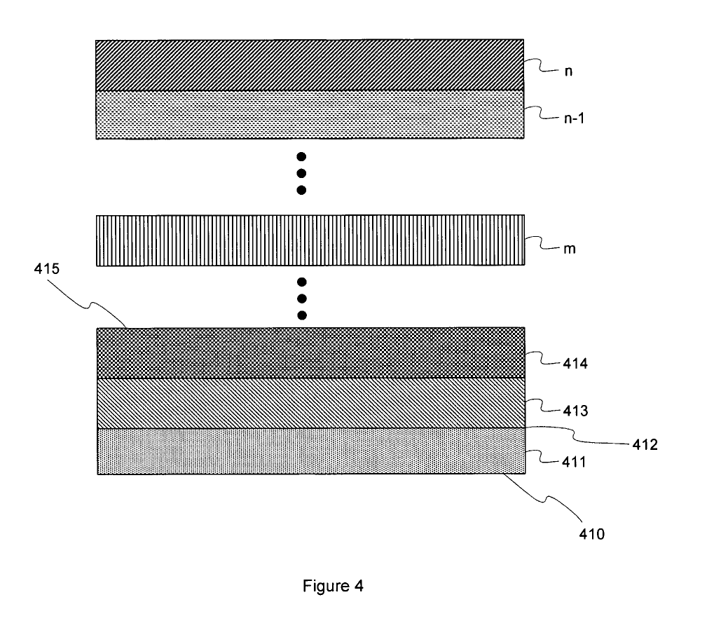

The functional role of various intermediate composite substantially plastic layers is further clarified by means of the example illustrated in FIG. 4, which might be a notional structure of a smart plastic intermediate composite useful for fabricating a flat panel liquid crystal display. The composite structure, which may be, for example, the support sub-layer 208 of FIG. 2, has properties tailored in accordance with the illustrative embodiments of the present invention. The smart composite comprises a sandwich stack of n parallel layers labeled 411, 413, 414, . . . , m, . . . , n−1, n, which are fabricated from polymeric substrate materials, and may be optically isotropic or anisotropic materials. It is to be understood that the number of layers n may vary according to the desired properties.

Multi-Layer Barrier Composite with Embedded Functionality

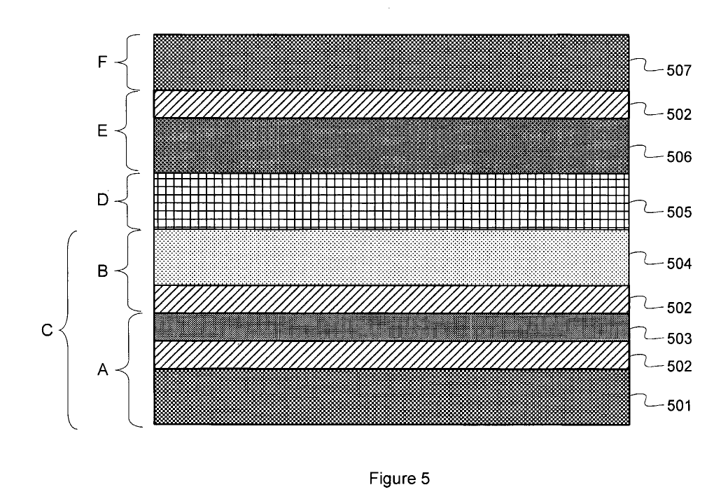

Referring now to FIG. 5, there is shown an example of the role played by intermediate composites with barrier property as an embedded functionality. A composite film laminate is fabricated to have a particularly high gas barrier effect and also good optical transparency in the visible spectrum, as well as good mechanical and thermal properties. Multistep photolithography to prepare active devices on polymer substrates requires dimensional stability of the substrate. Dimensional changes may occur because of absorption of moisture and solvents during etch and rinse steps. It is useful to develop laminate composite material that provides a suitable barrier to water and solvents. In the following illustrative example, the multilayer barrier composite comprises a set of three intermediate composites arranged in a sequence which will be detailed below.

Intermediate composites A and B comprise at least one polymer substrate which is coated with non-stoichiometric optically transparent silicon oxide (SiOx) or a metal oxide selected from s-block group 2 or p-block element groups 3 or 4, by vapor deposition. Intermediates A and B are bonded together with a tie-layer (adhesive layer) to give an intermediate composite C. Another film D, which may be an additional moisture and oxygen barrier layer, is coated on intermediate composite C. Substrate layer E is an intermediate composite layer coated with SiOx or a metal oxide selected from s-block group 2 or p-block element groups 3 or 4 by vapor deposition. The skin layer F may be another intermediate composite comprising a thermoplastic resin selected, for example, from the family of polyesters, polyamides, polyolefins or copolymers thereof, or from the family of polymers as mentioned above in the description of FIG. 4. Intermediate composites C, D, E and F are combined to give the final barrier composite. The specific order and thickness of the constituent films may be arranged so as to meet specific requirements. Multiple intermediate composites C may also be used to further enhance barrier properties. Moreover, the SiOx and related ceramic coatings (SiNx, non-stoichiometric silicon oxynitride, and metal oxides selected from s-block group 2 or p-block element groups 3 or 4 by vapor deposition), may be applied to both sides of a single layer or multiple layer polymer film to provide enhanced barrier and thermomechanical properties. Methods of vapor coating are well known to those of ordinary skill in the art. The application of the ceramic layer to the film is carried out so as to give an oxide layer thickness preferably in the range from 30 to 100 nm. The web speed of the film to be coated is chosen as required to give this thickness.

Substrate layers A, B and/or D and/or E may also be fabricated from a coextrudate of different polymers. The coextrudate may consist of one or more layers of one of the above mentioned thermoplastic resins, and a gas barrier layer of resin, selected for example, from a partially hydrolysed ethylene vinyl acetate (EVOH) polymer. The barrier layer is sandwiched particularly between two layers of the mentioned thermoplastic resins.

If a polyamide vapor-coated with SiOx or a metal oxide from p-block element groups 3 or 4 is positioned as the substrate surface layer A, the resulting film composite is also distinguished, in addition to the low gas permeability values, by high mechanical stability.

Adhesives such as, for example, commercial reactive 2-pack polyurethane adhesives may be used for the bond between the individual layers of the laminate composite. Polyolefinic adhesion promoters, for example polyethylene, ethylene ethyl acrylate (EEA) or ethylene methyl methacrylate (EMMA), or other promoters known to those of ordinary skill in the art may also be used.

In the illustrative example shown in FIG. 5, the film composite is a laminate of:
A a polyamide layer 501 vapor-coated with SiOx 502 on which is applied an adhesive 503;
B a polyester layer 504 vapor-coated with SiOx 502;
D an EVOH barrier layer 505 having 30% of the acetate groups hydrolysed;
E a polyester layer 506 vapor-coated with SiOx 502; and
F a poly(ethylenenaphthalene) (PEN) skin layer 507.

The film composite laminate is produced as follows: Individual substrate layers A and B vapor-coated with SiOx are first laminated as shown in FIG. 5 to give an intermediate composite C. This lamination is performed by means of a polyurethane (polyisocyanate and polyol)-based adhesive system. The urethane components are stoichiometrically adjusted to prevent carbon dioxide formation during adhesive curing. A lamination in a low humidity (humidity-controlled) clean room of class 10000 or better is preferred. Polyester layer E vapor-coated with SiOx is laminated with the SiOx side adjacent to the PEN skin layer F.

An EVOH layer D is laminated on the already produced intermediate composite C. This composite consisting of C and D is laminated together with the already produced composite from combining layers E and F in a final step. The laminations are typically carried out at speeds generally between 100 and 300 m/min, and preferably between 150 and 250 m/min. Other speeds may be possible depending on laminating equipment specifications. The composite laminate will exhibit low permeability for oxygen (<0.08 cm³-m⁻¹-bar specified by DIN 53380-3) and water vapor (<0.08 g/m² at 35° C. by DIN 53122). Other combinations of polymers and other orders of layers may be envisaged. For example, a thin layer of liquid crystal polymer with substantially improved barrier properties may be laminated to the surface of one face of another polymer layer. Areas of application for barrier composites include laminates for solar panels, substrates for liquid crystal displays, substrates and superstrates for light emitting diodes, and substrates for organic transistors. Moreover, when the thermal expansion coefficient of the composite barrier layer is known, then this composite structure may be combined with another having an opposing coefficient of thermal expansion such that the total composite structure has low or zero thermal expansion over a given range of temperature. In this way, a degree of dimensional stability is conferred on the total composite structure.

### Smart Thermal Composite

Heat stabilization releases residual strain effects within oriented regions of a plastic film. When properly heat stabilized, certain plastic films remain dimensionally stable and reproducible up to significantly high substrate temperatures. Heat stabilization at temperatures above the glass transition for extended periods of time may further reduce shrinkage in plastic films. However, polymers generally have much larger coefficients of thermal expansion than other materials like conventional glasses. When polymers are combined with other materials having dissimilar thermal expansion coefficients, temperature change may build up tensile and other stresses into thermoplastic materials, if their thermal expansion is hindered. It is desirable to have a composite laminate material that has a tailored thermal response so that it does not expand or contract, or shows predictable or controllable thermal expansion (contraction) with temperature. Without the use of electrical or other kinds of sensing and intervention, certain layer materials may be made that will automatically adapt to changes in the ambient temperature so that they behave in a more or less athermal manner. This self-adaptive, or smart, behavior would be particularly attractive in the application of plastic substrates that have active electronic devices such as thin film transistors printed on them. The fabrication of such devices requires a high degree of precision in patterning the fine line elements used to make the TFT by multi-step photolithography. Thermal expansion and contraction of the polymer surface to which the transistor device is attached may destroy its function.

For polymers, thermal expansion is different above and below the glass transition temperature. The dominant factor that leads to warpage in asymmetric laminates is the difference in coefficient of thermal expansion of the individual layers. By selecting the appropriate combinations of layers in the composite it is possible to reduce the dimensional movement by controlling the thermal expansion or contraction of the material. Therefore, it is possible to create a smart composite material including an intermediate composite laminate, and which exhibits athermal behavior. Referring back to FIG. 4, the composite comprises a substrate 411, having a bottom surface 410 and a top surface 412, the substrate 411 having a thermal coefficient of expansion. The smart composite further comprises a layer 414, having a bottom surface 413 and a top surface 415, formed by bonding surface 413 to the surface 412 of the substrate 411. The layer 414 has a coefficient of thermal expansion characterized by a negative coefficient of the refractive index. For example, the amount by which the thickness of a film approximately changes due to expansion is approximately inversely proportional to the thermal change in the refractive index. This is given by the expression, Δd/ΔT≈−Δn/ΔT, where d is the thickness of the polymer and n is the refractive index, and ΔT is the change in temperature. The thermo-optical coefficient, G, is related to the linear coefficient of thermal expansion α, and the refractive index via G=α(n−1)+dn/dT. If the value of the term α(n−1) is the exact opposite of the one of the temperature coefficient of the refractive index dn/dT, then the thermo-optic coefficient G is identically zero. Thus if the temperature coefficient of the refractive index is sufficiently negative, a composite is made that is thermally stable (athermal).

Accordingly, a composite substantially plastic substrate has a tailored thermal response. The composite comprises a solvent-resistant substrate or intermediate composite comprising a surface, the substrate or composite having a coefficient of thermal expansion and comprising a material selected from one of, or combinations of, thermoplastic films such as poly(etheretherketone) (PEEK), poly(aryletherketone) (PAEK), poly(sulfone) (PSF), poly(ethersulfone) (PES, including Sumilite® FST-X014), poly(estersulfone), aromatic fluorine poly(ester), poly(etherimide) (PEI), poly(etherketoneketone) (PEKK), poly(phenylenesulfide) (PPSd), oxidized polyarylenes/polyarylene sulfide/polyarylene sulfone (“Ceramer”/“Cramer Plus”) (PPS/PPSO2), cyclic olefin copolymer (Appear™ 3000), polyarylate (AryLite™ A 100HC), poly(carbonate) (PureAce), poly(ethylenenaphthalene) (PEN, and isomers thereof (e.g., 2,6-, 1,4-, 1,5-, 2,7-, and 2,3-PEN)), (including Teonex Q65®), poly(ethyleneterephthalate) (PET, including Melinex ST504®, polybutylene terephthalate, and poly-1,4-cyclohexanedimethylene terephthalate)). Other polymers include polyimides (e.g., polyacrylic imides), polyalkylene polymers (e.g., polyethylene, polypropylene, polybutylene, polyisobutylene, and poly(4-methyl)pentene), fluorinated polymers (e.g., perfluoroalkoxy resins, polytetrafluoroethylene, fluorinated ethylene-propylene copolymers, polyvinylidene fluoride, and polychlorotrifluoroethylene), chlorinated polymers (e.g., polyvinylidene chloride and polyvinylchloride), polyacrylonitrile, polyamides, silicone resins, and epoxy resins. The laminate structure further comprises a polymer layer formed on the surface of the substrate or intermediate composite laminate consisting of a plurality of layers. Said polymer layer has a temperature dependent refractive index characterized by a negative thermo-optical coefficient. Certain polymer layers compatible with illustrative embodiments of the present invention have negative thermo-optical coefficients that range between −2×10⁻⁵/° C. and approximately −18×10⁻⁵/° C. For example, substrate 411 having a bottom surface 410 and a top surface 412 may be chosen from the class of polymer materials given above.

In an exemplary embodiment, the solvent resistant substrate 411 comprises a poly(arylate) such as Arylite™ A 200 HC. This material has a refractive index (633 nm) of 1.64 and a coefficient of thermal expansion of 53 ppm between −55 and +85° C. It is resistant to acetone, methylethyl ketone, methanol, ethanol, iso-propanol, ethylacetate, hexamethyldisilazane, n-methylpyrrolidone, tetrahydrofuran, toluene, glacial acetic acid, 48% HBr, 37% HCl, is slightly deformed in 70% nitric acid, and 98% sulfuric acid, but is unreactive to 83% phosphoric acid, 30% hydrogen peroxide 40% ferric chloride and saturated solutions of sodium carbonate, sodium hydroxide, and potassium hydroxide. In the temperature range of interest, this means that the overlayer on Arylite™ will have a temperature coefficient of the refractive index do/dT of approximately −34×10-6° K⁻¹ in order that the thermo-optic coefficient is zero and the material behaves in an athermal fashion.

### Plastic Liquid Crystal Display

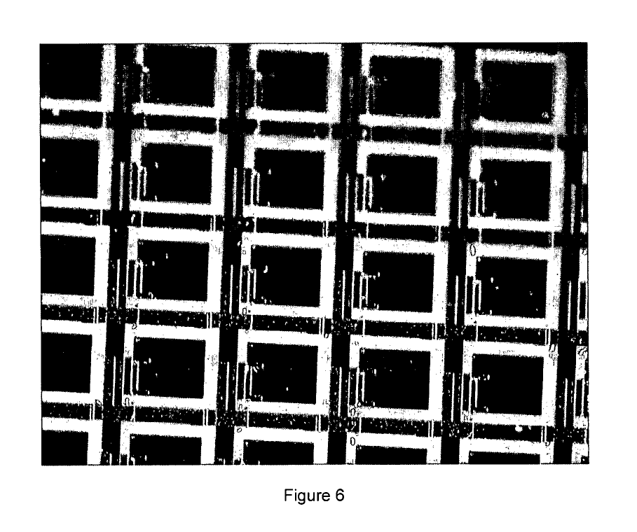

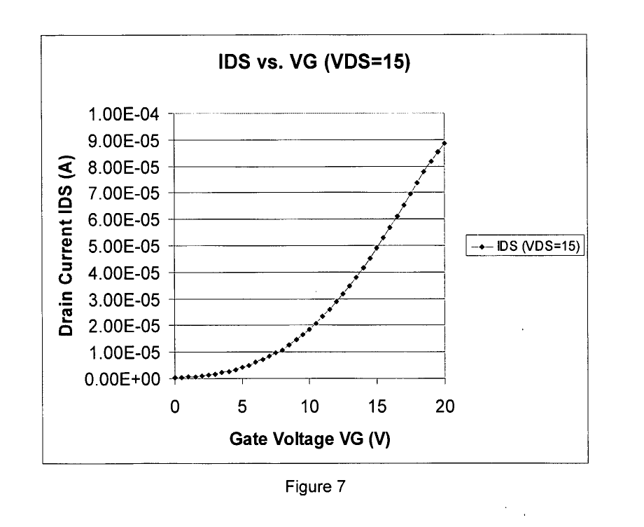

In this example the fabrication of a function plastic liquid crystal display device is described. The example puts into practice the idea of combining the functionality of several layers to give a single composite film structure exhibiting embedded electronic functionality. In an exemplary embodiment, a poly(arylate) such as Arylite™ A 200 HC is used to form the bottom plastic layer with embedded functionality. A sample of the film is cleaned and annealed under vacuum. The sample is then patterned with aluminum metal in a subsequent patterning step. Accordingly a series of photolithography steps is implemented first to fabricate aluminum data lines to address the TFTs. The techniques for fabricating such lines are well known to those of ordinary skill in the art of making TFTs. In subsequent steps, a thin film transistor is fabricated similar to the method described in U.S. Pat. No. 6,225,149. A photograph of a typical pixel is shown in FIG. 6. The pixel area is overcoated with a transparent gold or ITO electrode. This completes the fabrication of the plastic layer, which now contains the embedded electronic functionality of an array of TFTs. This is a free-standing plastic composite film whose functionality is demonstrated by testing the individual TFTs. A current vs voltage curve for a given transistor is shown in FIG. 7. This composite with embedded functionality is available in sheet farm of plastic electronically functional windows for plastic liquid crystal display applications. To complete the functional plastic LCD, a nematic phase liquid crystal such as Merck E7 is mixed with a suitable quantity of ultra-violet light sensitive acrylate monomer. This fluid is subsequently mixed with 2 μm spacer beads (source: Sekisui Products) and a plastic film coated on one side with ITO is pressed into the fluid. The entire unit is then exposed to UV light, which causes the LC to phase separate from the polymer, whilst simultaneously bonding the ITO plastic layer to the composite layer with the embedded TFT functionality. The flexible plastic composite liquid crystal device may then be switched with a suitable applied voltage.

Although the present invention has been described by way of particular embodiments and examples thereof, it should be noted that it will be apparent to persons skilled in the art that modifications may be applied to the present particular embodiment without departing from the scope of the present invention.

1. A shapeable multilayer composite comprising dimensional stability, the composite comprising:
at least two polymer substrates, each polymer substrate comprising a first and a second surface, the at least two polymer substrates being positioned sequentially;
wherein the two polymer substrates are bonded together.

2. The shapeable multilayer composite of claim 1, wherein the two consecutive polymer substrates are bonded together using an adhesive layer positioned between the second surface of one of the two consecutive polymer substrates and the first surface of the other of the two consecutive polymer substrates.

3. The shapeable multilayer composite of claim 2, wherein the adhesive is a 2-pack polyurethane.

4. The shapeable multilayer composite of claim 2, further comprising an adhesion promoter.

5. The shapeable multilayer composite of claim 4, wherein the adhesion promoter is selected from a group consisting of polyethylene, ethylene ethyl acrylate and ethylene methyl methacrylate.

6. The shapeable multilayer composite of claim 1, wherein each two consecutive polymer substrates are bonded together using a method selected from a group comprising extrusion coating, extrusion laminating, film casting, flexographic coating and a combination thereof.

7. The shapeable multilayer composite of claim 1, wherein at least one surface of at least one polymer substrate is coated with an optically transparent coating.

8. The shapeable multilayer composite of claim 2, wherein the optically transparent coating is selected from a group consisting of SiOx, SiNx and metal oxide from s-block group 2 and p-block groups 3 and 4.

9. The shapeable multilayer composite of claim 1, further comprising a moisture and gas barrier layer coated onto at least one surface of at least one of the polymer substrates.

10. The shapeable multilayer composite of claim 9, wherein the moisture and gas barrier layer is a partially hydrolysed ethylene vinyl acetate polymer.

11. The shapeable multilayer composite of claim 1, further comprising a thermoplastic resin.

12. The shapeable multilayer composite of claim 11, wherein the thermoplastic resin is selected from the group consisting of polyester, polyamides, polyolephins and copolymers thereof.

13. The shapeable multilayer composite of claim 11, wherein the thermoplastic resin is bonded to at least one of the at least two polymer substrates using an adhesive layer positioned between the thermoplastic resin and the at least one polymer substrates.

14. The shapeable multilayer composite of claim 13, wherein the adhesive is a 2-pack polyurethane.

15. The shapeable multilayer composite of claim 13, further comprising an adhesion promoter.

16. The shapeable multilayer composite of claim 15, wherein the adhesion promoter is selected from a group consisting of polyethylene, ethylene ethyl acrylate and ethylene methyl methacrylate.

17. The shapeable multilayer composite of claim 11, wherein the thermoplastic resin is bonded to at least one of the at least two polymer substrates using a method selected from a group comprising extrusion coating, extrusion laminating, film casting, flexographic coating and a combination thereof.

18. The shapeable multilayer composite of claim 1, wherein the at least two polymer substrates are selected from the group consisting of polyethylene-terephthalate, polyethylene-naphthalate, poly-carbonate, polyether-sulfone, polyarylate, poly-norbornene, polycyclic olefin, polycarbonates, polymethacrylates, polyacrylates, polystyrenes, polyalkylene polymers, fluorinated polymers, chlorinated polymers, polyacrylonitrile, polyamides, silicone resins, epoxy resins, polyvinylacetate, polyether-amides, ionomeric resins, elastomers, polyurethanes, poly(etheretherketone), poly(aryletherketone), poly(sulfone), poly(ethersulfone), poly(estersulfone), aromatic fluorine poly(ester), poly(etherimide), poly(etherketoneketone), poly(phenylenesulfide), oxidized polyarylenes/polyarylene sulfide/polyarylene sulfone, cyclic olefin copolymer, polyarylate, poly(carbonate), poly(ethylenenaphthalene), poly(ethyleneterephthalate) and combinations thereof.

19. The shapeable multilayer composite of claim 13, wherein the at least two polymer substrates are in the form of biaxially oriented films.

20. The shapeable multilayer composite of claim 1, wherein at least one of the polymer substrates is selected to comprise a coefficient of thermal expansion which when combined with the lumped coefficient of thermal expansion of all of the other polymer substrates results in a coefficient of thermal expansion generally equal to zero.

21. The shapeable multilayer composite of claim 1, wherein at least one of the polymer substrates is selected to comprise a coefficient of thermal expansion which when combined with the lumped coefficient of thermal expansion of all of the other polymer substrates results in a negative coefficient of thermal.

22. The shapeable multilayer composite of claim 1, wherein at least one of the polymer substrates is selected to comprise a coefficient of thermal expansion which when combined with the lumped coefficient of thermal expansion of all of the other polymer substrates results in a positive coefficient of thermal.

23. A shapeable composite material for use in the fabrication of liquid crystal displays, the composite material comprising:
a first support composite comprising a top and a bottom surface, the bottom surface of the first support composite comprising a first transparent electrode disposed thereon;
a second support composite comprising a top and a bottom surface, the top surface of the second support composite comprising a second transparent electrode disposed thereon; and
a liquid crystal layer disposed between the bottom surface of the first support composite and the top surface of the second support surface;
wherein the first and second support composites are shapeable multilayer composites of claim 1.

24. The shapeable composite material of claim 23, further comprising a first polarizer layer disposed on the top surface of the first support composite and a second polarizing layer disposed on the bottom surface of the second support composite.

25. The shapeable composite material of claim 24, wherein the first polarizer layer is embedded in the first support composite and the second polarizer layer is embedded in the second support composite.

26. The shapeable composite material of claim 23, further comprising a first protective layer disposed on the top surface of the first support composite and a second protective layer disposed on the bottom surface of the second support composite.

27. The shapeable composite material of claim 26, wherein the first and second protective layers are selected from a group consisting of a polymer, an acrylate, an alkoxysilyl substituted acrylate and an acrylate containing between 20 and 80% silica particles.

28. The shapeable composite material of claim 26, further comprising a first polarizer layer disposed between the first protective layer and the top surface of the first support composite and a second polarizing layer disposed between the second protective layer and the bottom surface of the second support composite.

29. The shapeable composite material of claim 28, wherein the first polarizer layer is embedded in the first support composite and the second polarizer layer is embedded in the second support composite.

30. The shapeable composite material of claim 23, further comprising a hard coat deposited on at least one surface of at least one of the support composite.

31. The shapeable composite material of claim 30, wherein the hard coat material is selected from a group consisting of SiO2, tantalum oxide, silicon oxynitride and combinations thereof.

32. The shapeable composite material of claim 31, wherein the hard coat has a thickness between 500 nm and 750 nm.

33. The shapeable composite material of claim 31, wherein the hard coat material is selected from a group consisting of SiOx, a spin-on-glass, a titanium oxide doped silica spin-on-glass and combinations thereof.

34. The shapeable composite material of claim 33, wherein the hard coat is printed onto the at least one surface of at least one of the support composite.

35. The shapeable composite material of claim 34, wherein the hard coat is printed using a flexo printer and annealed in a furnace.

36. The shapeable composite material of claim 23, wherein the first and second transparent electrodes comprise a material selected from a group consisting of indium-tin-oxide, an alloy of indium-tin-oxide and gold, and zinc oxide.

37. The shapeable composite material of claim 23, wherein the first and second transparent electrodes are counter electrodes.

38. A method for forming a shapeable composite material suitable for forming a liquid crystal display, comprising:
a) providing a first support composite comprising a top and an bottom surface, the bottom surface of the first support composite comprising a first transparent electrode disposed thereon;
b) providing a second support composite comprising a top and an bottom surface, the top surface of the second support composite comprising a second transparent electrode disposed thereon;
c) positioning a liquid crystal film between the bottom surface of the first support composite and the top surface of the second support surface; and
d) bonding the first and second support composites together;
wherein the first and second support composites are shapeable multilayer composites of claim 1.

39. The method of claim 38, wherein steps a) and b) further comprise attaching a rigid substrate to the first and second support composites with a release agent, wherein the method further comprises step e) of releasing the rigid substrates.

40. The method of claim 39, wherein the release agent is a temporary adhesive.

41. The method of claim 38, further comprising:
e) applying a first protective layer to the first support composite; and
f) applying a second protective layer to the second support composite.

42. The method of claim 38, further comprising t:
e) applying a first polarizer to the first support composite; and
f) applying a second polarizer to the second support composite.

43. The method of claim 42, further comprising:
g) applying a first protective layer to the first polarizer; and
h) applying a second protective layer to the second polarizer.

44. A method for forming a shapeable composite material suitable for forming a liquid crystal display, comprising:
a) providing a first support composite comprising a top and an bottom surface, the bottom surface of the first support composite comprising a first transparent electrode disposed thereon;
b) providing a second support composite comprising a top and an bottom surface, the top surface of the second support composite comprising a second transparent electrode disposed thereon;
c) patterning the transparent electrodes disposed the first and second composites;
d) forming registration features in the first and second composites;
e) filling the registrations features with liquid crystal fluid; and
f) bonding the first and second support composites together;
wherein the first and second support composites are shapeable multilayer composites of claim 1.

45. The method of claim 44, wherein steps a) and b) further comprise attaching a rigid substrate to the first and second support composites with a release agent, wherein the method further comprises step g) of releasing the rigid substrates.

46. The method of claim 45, wherein the release agent is a temporary adhesive.

47. The method of claim 44, further comprising:
g) applying a first protective layer to the first support composite; and
h) applying a second protective layer to the second support composite.

48. The method of claim 44, further comprising:
g) applying a first polarizer to the first support composite; and
h) applying a second polarizer to the second support composite.

49. The method of claim 48, further comprising:
i) applying a first protective layer to the first polarizer; and
j) applying a second protective layer to the second polarizer.
